(19) United States
(12) Patent Application Publication
(10) Pub. No.: US 2026/0192907 A1
(43) Pub. Date: Jul. 9, 2026

(54) SOLAR PANEL ARRANGEMENT FOR A SAILING VESSEL

(71) Applicant: Cameron Michael Burdgick, Ann Arbor, MI (US)

(72) Inventor: Cameron Michael Burdgick, Ann Arbor, MI (US)

(21) Appl. No.: 19/009,990

(22) Filed: Jan. 4, 2025

(51) Int. Cl. B63J 3/02; B63J 3/00; H02S 20/30; H02S 30/20

(52) U.S. Cl. CPC B63J 3/02; H02S 20/30; H02S 30/20; B63J 2003/003

(57) ABSTRACT

This invention relates to the method of configuring a solar panel array vertically distributed on a sailing vessel for the purpose of improved solar energy capture and arrangement thereof. The primary objective is to substantially increase energy absorption area compared to existing designs for more efficient and expeditious recharging of batteries. The solar panel array uses an existing toplift halyard on a sailing vessel to raise the solar panel array while using self-centering connection points above the top solar panel. Base, therefore array, adjustment is achievable by adjustable base lines to the deck fixed points or a pulley system. The array's frame system ensures robustness to wind and configurability for various types of solar panels. Solar array system uses existing features without the need for permanent hardware or configuration changes to typical sailing vessels. Nesting and mounting embodiments are included in alternate design methods.

### FIELD OF THE INVENTION

The subject matter disclosed herein relates to a solar panel array configuration for use on a sailing vessel with vertically oriented mast and top lift for deployment of the multiple solar panel array. More particularly, aspects of the invention include various configurations related to the attachment at the lowest base panel, horizontal frame configuration, configurability to tilt panels and adjustability of the system.

### BACKGROUND OF THE INVENTION

Sailing vessels typically require electricity in some form to charge a battery bank. The battery bank on sailing vessels are used to run onboard accessories, electronics for navigation, refrigerator and freezer and similar items. Modern sailing vessels are also shifting to hybrid propulsion systems that combine an electric motor with a diesel combustion engine, instead of a diesel only system. In addition, fully electric propulsion motors have been introduced for sailing vessels, turning a propeller or jet pump to replace traditional diesel combustion engines. While sailing in remote locations, whether anchored or on a mooring ball, there is no shore power. During these situations the only methods for energy creation to charge the onboard batteries is to turn on the engine, turn on an onboard generator if it exists, use an installed wind power generator if it exists, or use solar panels.

Each of these methods of energy creation has distinct benefits, drawbacks and challenges. Running the main engine or using an onboard generator is costly, noisy, creates heat, and is not able to generate battery charging power during times humans are not present. In addition, internal combustion engines, whether the main engine or a generator, burn fossil fuels to operate. Both the production of such fuels and engine exhaust gas from burning such fuels are harmful to the environment. While fossil fuels have a very high energy density, their usage also requires resupply at given intervals and stocking of fuel onboard, adding to the weight of the vessel.

Using wind generation requires the purchase and installation of fixed base equipment. Additionally, wind generation using small blade sizes results in unwanted noise and very limited power output. The increasing efficiency and affordability of solar panels have made solar power a popular choice for sailboats, despite limitations. Solar power can be limited by location, permanent or non-permanent installation, panel orientation relative to sun position, and most significantly, limited area available on a sailing vessel for large area solar panels. These limitations have led to the present invention.

It is generally known that solar energy can be converted into electrical energy by means of solar panels. Photovoltaic panels or modules are routinely used for capturing this energy and are known in multifarious designs and therefore does not call for further explanation. Flexible photovoltaic panels are further known, in which the individual photovoltaic elements are flexible and often arranged on a flexible flat or curved structure. Flexible solar panel design and construction is also essentially known and therefore does not require further exposition.

Photovoltaic solar panels absorb energy from sunlight to facilitate generation of electricity, in this case for storing that energy in a bank of batteries on a sailing vessel. There have been different approaches to using solar panels on a sailing vessel. Fixed, permanent, equipment has very limited locations for installation on a sailboat due to the amount of rigging (lines, ropes) and open deck space that is needed for unimpeded movement about the vessel. Typical “permanent” placement for solar panels is on top of the bimini. A general application of solar panels in the form of a bimini can be seen in U.S. Pat. No. 1,176,4726 Wynn. However, in this application it is not applied to a sailing vessel for limitations exist within the land-based design addressed in the patent. A sailing vessel bimini typically consists of a canvas covering over the cockpit area that is attached to framework mounted to the topdeck (deck) of the sailing vessel. These bimini mounted panels may be flexible or rigid. A secondary placement area is typically a framework extension behind, or aft, of the cockpit area. There are semi-permanent mounting of limited size solar panels, usually on a pedestal connected to the vessel deck. These deck panels may be flexible or rigid. Another semi-permanent mounting location is the forward part of the vertically extending mast. The mast mounting of horizontal panels could result in permanent railing or retainment features for the manual deployment of horizontal panels attached to the mast guide rail system, if done using the forward portion of the mast. Lastly, non-permanent flexible solar panels can be stacked vertically with limited area and high susceptibility to wind damage due to small single line attachment.

The mast, being of substantial vertical height, allows for a multitude of solar panels and large panels with the use of a frame structure. Current usage of solar panels on sailboats are limited due to flexibility of the panel and support structure, lines, required to stabilize such flexible panels. Even medium wind conditions, common at most sailing locations, limit the use of flexible panels and could cause significant damage to the same.

One of the major drawbacks of solar panel energy generation on sailing vessels is the limited size of the panels, therefore, the time required to accumulate significant energy storage by way of the onboard batteries. As energy demands on a sailboat increase with the advent of electric propulsion and increased navigation equipment and hand-held device recharging needs, more energy replenishment is required. Many sailors do not have access to unlimited shore power and require other generation methods. Most of the current solar panel usage on sailing vessels requires considerable time in the sun to recharge the batteries, due to either limited solar panel area or due to limited output by using less efficient flexible panels.

The problem with many solar panel installations on mobile vehicles, in this case a sailboat, is the attachment and orientation of said panels in such an attitude that they are exposed or optimized to the incident sunlight or daylight in order to achieve a high efficiency.

### SUMMARY OF THE INVENTION

The invention relates to an arrangement of solar panels for a sailboat being deployed by existing mast head lifting line or halyard, which are substantially vertically equidistant while projecting in a horizontal direction in the use or deployed position.

The invention provides novel use of commercially available solar panels, connection line arrangement for optimized deployment and lift kinematics, frame support structure for large panel deployment, nesting feature with optional adjustable mounting feature, and non-permanent solar panel system requiring minimal, if any, physical changes to the sailing vessel. Although flexible panels are lightweight, they are also less efficient and more expensive. However, this invention can be used with rigid or flexible panels, or a combination of both.

It is intended, but not limited to, the sailboat being in a non-moving state in which the forward sail, the jib, is not in use for the deployment of the solar panel array. However, while the boat is not moving, whether docked or moored, or while the boat is motoring, the panels can significantly contribute to recharging onboard batteries or maintaining high levels of stored energy within them. The invention addresses several of the main drawbacks to current solar panel usage on a sailboat. Primarily, the limited deck space available for solar panel usage on a sailboat is addressed by this invention. Additionally, addressing the use of flexible panels that greatly limit the size of the panels, therefore greatly extending the time needed to store the solar energy and the efficiency thereof. This invention and its various embodiments address the manual labor required to install panels into a track system on the mast, or permanent installation of pylons for temporarily holding larger solar panels on the deck. Flexible panel and large-panel pylon mounted solar panels have been known to be susceptible to damage from high winds. Making flexible panels robust to wind damage requires limiting the size of the flexible panel to smaller than desired for energy capture area. This invention also addresses the limited space to deploy panels on a sailboat. The invention supports larger flexible panels and the ability to use large heavy panels that are known to be more efficient and less expensive than flexible panels.

Furthermore, this design doesn't require a central hole, which would exist if a single central lifting line is used, such as relying solely on the main halyard to support the array. Such central holes in each panel would reduce the available surface area for capturing sunlight. This design also allows for nonsymmetrical, rectangular in this case, panels which could be unstable in a central support design.

Furthermore, this design does not compete for the same space as other solar panel usage on a sailboat. This does not require special mast rail sliders to be purchased and the time-consuming task of deploying a mast assisted panel deployment.

According to the invention solar panels are generally equally distributed in a vertical direction having the base solar panel frame connected, with lines, to the foredeck of the sailing vessel at existing or installed connection points. The panel width and vertical spacing between panels would be optimized based on both the number of panels and allowable lift height to capture the most solar energy without substantial shadowing of each panel from above panels. Computer modeling can assist in optimization of such geometric parameters based on sailing vessel size, geometric constraints, and finally, based on earth position to account for the sun's relative position through the day. The vertical deployment of the interconnected panels is done by a lift line provided through the top of the mast; the line commonly referred to as a halyard. The solar panels are arranged horizontally to the sailing topdeck and mutually perpendicular to the sailboat mast. The solar array can consist of any number of panels within the geometric constraints of each sailing vessel. That number would also vary based on spacing required to reduce shadowing of upper panels onto lower panels due to the sun's relative position. Generally, the panels would be at least two but could go beyond ten panels for a larger vessel. Connection points are predetermined between each panel by way of the lift lines. The connection points are preferably in the four corners of each solar panel frame and determinately fixed by flexible connection. Such connection types to the panels can be done by tying, slip clamps carabiners to line loops, or similar rigid by flexible connection.

Moving to the uppermost solar panel connection, the continuous forward and aft lines connecting the forward and aft panel corners respectively allow for single lift points leading up to the main halyard. In the preferred embodiment each of the main panel connection lines would be interconnected to a secondary forward to aft line by way of a pulley connection. The pulley connection allows for side-to-side self-centering of the panel allowing for horizontal or tilting adjustment to be done without having to manually change the connection point at the top solar array connection point. It is advantageous to use a pulley configuration called a “single rope fixed eye pulley”, or a “swivel eye single pulley”, either pulley being commercially available and well known.

Connecting to the forward and aft main solar panel continuous lift lines is a secondary continuous lift line between the panel main lines and the top halyard. This secondary line is ideally connected to the halyard using a single rope fixed eye pulley or similar. This single eye pulley connection allows for forward and aft self-centering of the main solar panel lift lines and thereby array forward and aft positioning. Using the two lower pulleys to the main lift lines and the central pulley to the halyard allows for complete system kinematics to self-center the vertically distributed solar array. Most advantageous is the ability to quickly adjust the lower foredeck connection lines to optimize the solar panel attitude, or tilting, for improved solar energy capture.

The main connection points of the continuous main solar panel forward and aft lift lines is done by way of rigid connection points on the vessel foredeck, though not limited by such location on the vessel. The connection points can be simple tying of each of the four bottom lines to a continuous toerail hole or cutout. Common among sailing vessels is a vertically continuous toerail, generally 1.5 to 2.5 inches high with cutouts or holes. Other methods of attachment could be to a permanently mounted cam cleat with a fairlead hole, or an extending or below surface eyelet. The use of a cam cleat allows for quick and rigid connection of the solar panel array base lines. Finally, the mount points could be to existing deck cleats or chainplate (fixed deck mounted eyes) features.

In one embodiment the frame structure, used in combination with the flexible solar panel, would consist of an aluminum frame using primarily square tubing. The aluminum frame would be constructed out of square tubing of gauge 19 to 14 wall with a tubing width of 0.625 to 1.25 inch square. Frame to have welded joints at intersections. In another embodiment the joints could be pinned or screwed together with corner brackets accepting the square tubing. Finally, the tubing could be made from composite material, or similar lightweight and high strength material. Flexible or rigid solar panels to be affixed to frame upper surface by a semi-permanent or permanent attachment. Solar panel attachment can be done using temporary zip ties, screw and washer, or similar. Permanent attachment of flexible panels could include permanent high strength adhesive.

In the preferred embodiment the solar panels are oriented longitudinally parallel to the vessels forward to aft centerline, and coincident therewith. This allows for the significant stability needed in higher winds and for proper orientation of panels. Panels can remain horizontal, parallel to the vessel foredeck, or they can be pivoted along the central axis to acquire a better view factor to the sun. In a separate embodiment the panels are to remain horizontal to the top deck without pivoting.

Although the preferred embodiment would have the solar panels oriented longitudinally parallel to the vessels, the entire array in a further embodiment, can be oriented 90 degrees to the vessel centerline to tilt the array forward and aft should it be desirable based on the sun's position relative to the boat. This, however, may not be advisable due to wind conditions in many ports while out on a mooring ball. Commonly, while anchored or mooring at a port, the prevailing winds will come from the front of the vessel towards the rear of the vessel as the vessel swings to align with the prevailing wind direction. This is commonly called anchor swing.

Another significant embodiment is the ability or configuration of moving the forward, or aft, connection points to the solar panels to achieve a more direct pull direction towards the top of the mast. On sailing vessels with limited locations for base to deck connections, specifically when there are limitations to how far forward connections can be made, this modification can greatly improve the structural kinematics of the solar arrangement, while allowing extension of the forward portion of each solar panel to achieve substantial area for energy capture. Without optimization of lift line to panel connection locations, the panel longitudinal length, therefore area, is limited to the kinematics of the central vertically upward pull axis between the top of the mast and the base four corner mounting locations. Allowing for extension of the forward or aft longitudinal length of the solar panel allows for a larger area to capture sunlight. Having the ability to optimize the connection point of the lift lines to the panels allows for substantial panel sizes. If the four corner points are used on all panels, then they will have to be reduced appreciably, from lowest to upper most, as the progress towards the top of the mast as the kinematics dictate the pull direction and arrangement.

The panels used can have, for example, dimensions of 12 to 36 inches in width by 48 to 96 inches in the longitudinal direction for a medium size sailboat. Allowing for increased size is the reliance on a lightweight frame structure to which the flexible, or non-flexible, solar panels are attached. Although not limited to a frame supporting structure the use of said frame allows for larger solar panel deployment than found in similar configurations currently achievable. The modular design of panel sizing, frame structure and connection point adjustability allow for multiple configurations to quickly optimize to the various sailing vessel sizes and deck limitations.

Distribution of the converted solar energy would be done through energy transmission wires or cables that are connected to common solar panel connection points. Transmission wires then continue through each panel connection following down one of the four connection lines to a final energy transmission wire to a solar charge controller and finally to the main battery storage bank. The electrical connection can be to a wire strung across the deck, through a port access, or ideally to a fixed interconnection point installed on the foredeck of the sailing vessel. The electrical connections to the sailboat battery bank, and to the individual photovoltaic solar panels are not shown, as the design of such electrical connections are known to those knowledgeable in the field or practice of solar panel system design and therefore is not specifically addressed as a novel design feature to the invention.

In another embodiment, the solar panel array can use the main forward and aft lift lines as the pivot point to allow side-to-side tilting for the panel array. The tilting can be done by using the previously mentioned connection points, preferably using cam cleats with a fixed fairlead hole, to quickly adjust the four main lower connection lines. The four lower connection lines can be the ends of the forward and aft continuous lines, or they can be separate lines that just adjust the attitude of the base solar panel, and thereby the connected array.

A further embodiment combines a nesting feature to the bottom solar panel frame and corresponding features on upper solar panel frames for the purpose of nesting the collapsed array of panels. The nesting feature consists of a vertically upward extending member permanently affixed near the four corner points of the base solar panel frame. Permanently attached, or integrated, to the remaining panels, in coincident positioning to the four vertically upward projecting frame extensions, would be female fitting connectors of the same shape. These connectors become self-aligning with the bottom frame male projections. This nesting of panels allows for the ease of stowing the system as a whole by way of straps or similar. The nesting feature can use various means of temporary non-movable connection between the panels and be locked by pinning of the connection after stacking or by straps around the collapsed array of panels.

Furthermore, a mounting system would be integrated into the bottom panel frame to allow for semi-permanent attachment of the collapsed and nested frames to the foredeck, or other location, on the sailing vessel. In one embodiment, the mounting system would consist of a male and female fit, vertically adjustable station, attached near the four corners of the bottom frame. A push pin or inserted pin would be used to fix the vertical extension length of each member corner. The base of each mounting feature would consist of a permanently mounted base with a permanently affixed and upwardly vertically extending member. This upwardly extending member would interface with a coincident female feature on the base frame for adjustment purposes to accommodate various deck mountings, as many decks have slopes and steps.

In a final embodiment, a set of pulleys are affixed generally midway along each side of the long end of the bottom base frame. In this embodiment there would be one forward and one aft lift line attached to the front and aft of each panel for vertical distribution. There would be a side line threaded over the side pulleys of the base panel and then to each of the remaining panels above the base panel. Having a continuous line around the side of the panels allows for quick adjustment of the solar panel array attitude or tilting along the panel longitudinal axis. A locking feature can be used to stop the pulley motion once the desired panel angular orientation is achieved. For example, a locking pin, locking screw or similar can be used. This tilting configuration can also be done 90 degrees to the described orientation, allowing for forward and aft tilting of the panels along the shorter width axis. Finally, the pulley tilting arrangement could be done simultaneously for both the longitudinal and transverse axis of the panel while deployed.

### BRIEF DESCRIPTION OF DRAWINGS

These and other features of this invention will be more readily understood from the following detailed description of the various aspects of the invention taken in conjunction with the accompanying drawings that depict various embodiments of the invention, in which:

FIG. 1 shows a three-dimensional perspective view of the preferred embodiment of the sailing vessel solar panel array according to various embodiments of the invention.

FIG. 2 is a perspective left, port, side view of the sailing vessel and solar panel array of a preferred embodiment.

FIG. 3 is a perspective left, port, side view of the sailing vessel and solar panel array of another embodiment showing extended panels past the main lift line.

FIG. 4 is a perspective front view of the sailing vessel and solar panel array of a preferred embodiment.

FIG. 5 shows a front perspective view, at an enlarged scale, showing an alternate embodiment with tilting solar panel array.

FIG. 6 shows a three-dimensional view of an embodiment of the solar panel and supporting frame structure from FIG. 1.

FIG. 7 shows a three-dimensional breakaway view of the corner of the solar panel frame as depicted in FIG. 6. View represents an embodiment of a nesting feature for storage of the solar panel array.

FIG. 8 is a three-dimensional view of an alternate embodiment showing the based mount supports for the stowed array panel. Lift features removed for clarity.

FIG. 9 is a three-dimensional view of an alternate method of adjustment for the solar array using forward and aft lift lines with continuous side lines for tilting panels.

FIG. 10 is a three-dimensional view of an alternate method of adjustment detailing the bottom frame of FIG. 9 that uses the side tilting mechanism.

### DETAILED DESCRIPTION OF THE INVENTION

It is noted that the drawings of the invention are not necessarily to scale. The drawings are intended to depict only typical aspects of the invention, and therefore should not be considered as limiting the scope of the invention. In the drawings like numbering represents like elements between the drawings.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It is further understood that the terms “front” and “back” are not intended to be limiting and are intended to be interchangeable where appropriate.

On a sailing vessel the term “bow” traditionally refers to the “front” of the vessel. Additionally, the terms “aft”, “rear” or “stern” refers to the “back” of the boat, sometimes called the “cockpit” area. The “cockpit” area typically contains the steering system and/or navigations system. It is further understood that the terms “left” and “right” are not intended to be limiting and are intended to be interchangeable where appropriate. On a sailing vessel traditionally the term “port” refers to the “left” side of the boat while looking forward towards the front of the boat. Finally, the term “starboard” traditionally refers to the “right” side of the boat while looking forwards towards the front of the boat.

The imaginary line between the bow and stern of the sailing vessel is considered the longitudinal centerline. The vertical upward projecting mast is mutually perpendicular to the longitudinal centerline and traverse, port-to-starboard, centerline of the sailing vessel's upper deck. The upper deck is the top upward facing portion of the sailing vessel. The sailing vessel has a horizontal boom that is attached near the bottom, or foot, of the mast and becomes the retainment of the sail when sailing. Atop the mast there is at least one spare halyard or line to pull up objects from the topdeck. Items to be lifted vertically can be sail heads, flags, repair personnel, or in this case, an array of solar panels. Around the sailing vessel top deck there may be a small vertically projecting toerail. This toerail is typically comprised of holes or slots to attach lines or carabiners. Hold-down cleats may also be spaced around the top deck for use in temporarily attaching docking lines to a dock.

The present invention will now be described more fully with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

Some additional terms traditionally used in sailing vessels for aiding detailed descriptions and understanding thereof. The term “foredeck” refers to the upward facing and horizontal surface forward of the mast. Chainplates are mounting fixtures that can be used to connect to stabilization wires for the mast or may be used for connecting other loads or tie-downs. Chainplates may be in the form of any eyelet, buried eyelet, or similar attachment feature.

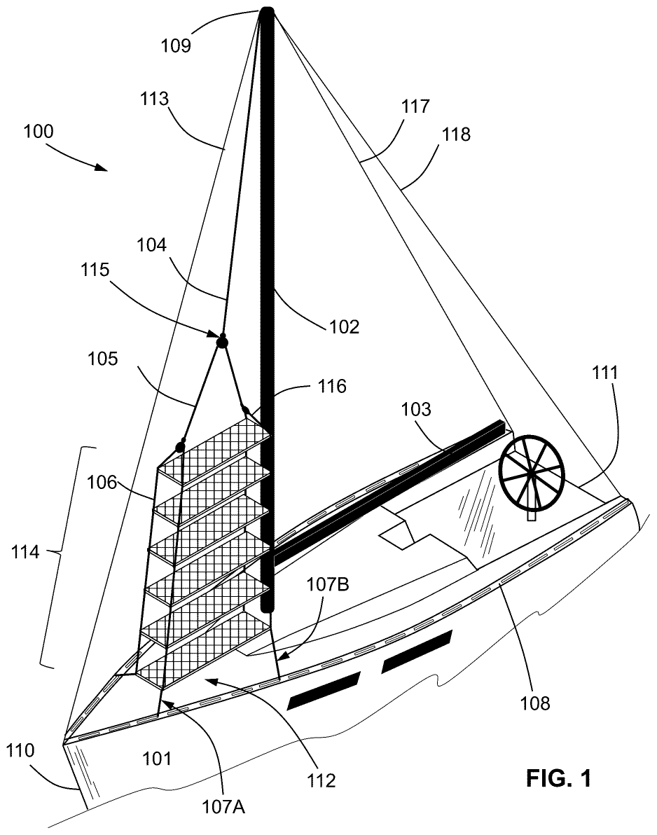

Referring now to the drawings which form the embodiments of the sailing solar array arrangement for large area capture, in accordance with the present invention as represented in FIG. 1. Perspective view FIG. 1 shows an array of mutually parallel and generally vertically equally distributed solar panels 114 for capturing solar energy. The panels 114 are shown in the deployed horizontal use position in accordance with the sailing vessel arrangement 100. Sailing vessel solar panel arrangement 100 is comprised of an upward projecting mast 102 that is mutually perpendicular to the sailboat 101 horizontal plane. The “boom” 103 is connected to and mutually perpendicular to the mast 102. Solar panel array 114 is shown over foredeck 112 and between forestay wire 113 and the mast 102. However, in another embodiment the solar panel array 114 could have the longer longitudinal sides oriented 90 degrees to the sailing vessel forward/aft centerline. The solar array 114 could also be placed generally over boom 103 or on the deck under the boom 103 and directly behind the mast 102, while not sailing.

Interconnecting front corners of each solar panel is a continuous line 106 and aft continuous line 116. In the main embodiment the panels are oriented along the sailing vessel forward to aft centerline. The main panel lines are then connected to a secondary lift line 105. Further secondary line 105 is then attached to a hoist line 104, or lift by way of a halyard, to vertically raise the array 114. Halyard 104 is attached to a pulley or hole in the mast top 109. Above the top solar panel and attached to line 106 and line 116 is a self-centering line 105 used by the halyard 104 to lift the solar array. The connecting member 115 would preferably be a single rope fixed eye pulley, or a swivel eye single pulley to allow for self-aligning of the forward and aft connecting lines 106 and 116. Item 110 refers to the forwardmost part of the boat while the aft portion 111 is opposite the forward end 110. There may be a toerail 108 that can be used to attach base mounting lines 107A and 107B on the left or “port” side of the vessel and lines 402A and 402B (not visible in view) on the right or “starboard” side of the vessel. The solar panel array 114 is generally deployed over the foredeck area 112. Wire 113 is used to stabilize the mast in the forward direction, while wires 117 and 118 are used to stabilize the mast in the aft directions. These show the restrictive area for deploying a solar panel array.

Base attachment lines forward 107A and aft 107B, along with corresponding base lines on the opposite of the sailboat centerline not shown, are connected between the vessel foredeck and base solar panel corner points. Base connections can be made to existing deck points or added fixed points to the sailboat deck 112. In the shown embodiment, base lines 107A and 107B are connected temporarily to the existing toerail 108. Each of the four base connection lines 107A and 107B, and two not shown, can be adjusted in length to change both the side-to-side attitude of the solar panels, but also can be used to adjust the horizontal attitude of the solar array 114 relative to the sailboat 101 horizontal front-to-back plane. Solar panels 114 are connected by a determinant, yet substantially flexible, connection at each of the panels four corner points.

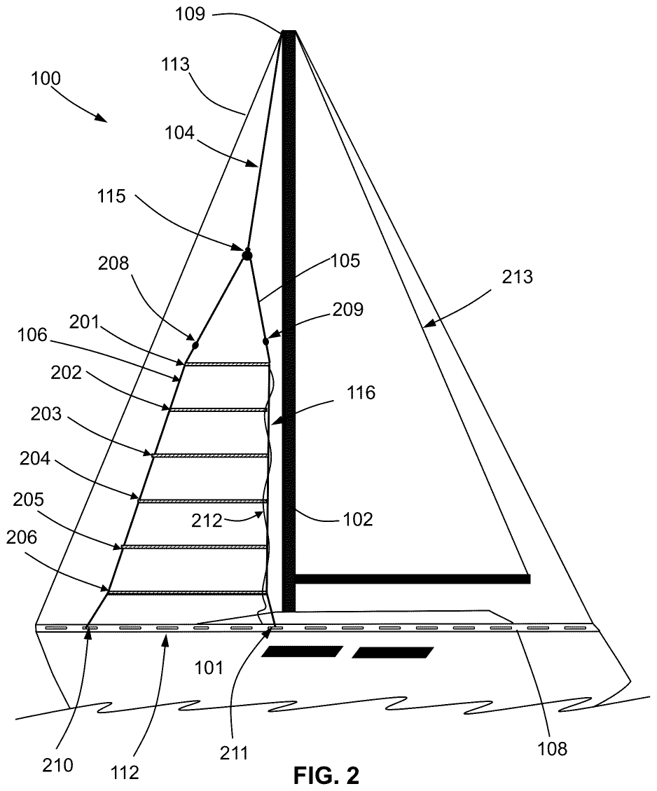

Referring to FIG. 2, is a side view of the sailing vessel for detailing the arrangement of solar panels within the given area between the forestay 113 and the mast 102. Halyard, main lift line 104 is shown attached to secondary continuous line 105 using connector 115. Connector 115 is preferably a single rope swivel pulley substantially connected to the bottom of halyard 104, allowing self-centering of the forward and aft panel connecting lines 106 and 116. Secondary lift line 105 is then substantially connected at each end to single rope fixed eye pulleys 208 and 209. The remaining ends of the fixed eye pulleys 208 and 209 are connected to forward and aft lines 106 and 116 respectively. The use of fixed eye pulleys 208 and 209 over which the forward and aft main lift lines 106 and 116 connect allows for the side-to-side self-centering of the panel elements 201 through 206. Solar panel elements 201 through 206 are composed of panel 600 and frame 601. However, the panel elements, 201 through 206, may be unified rigid panel solar panels. As previously described, the solar panel elements 201 through 206 are generally equally spaced in the vertical direction and substantially horizontal to the sailing vessel 101. Connections of solar panel composite elements 201 through 206 can be attached to lines 106 and 116 by way of tying, carabiners in line loops, clamping devices or similar.

The base of the solar array 114 is connected in the four corners by lines 107A and 107B and fixed at points 210 and 211 the toerail 108 or other permanent connection points to the deck. Base lines connection points 210 and 211 can be, in another embodiment, connected to clam cleats with fairlead holes, fixed deck eyes, deck cleats or similar. The use of clam cleats with fairlead holes is well known in sailboat designs, as they allow for quick adjustment of lines, yet rigid connections without slippage. Electrical wire 212 used for transferring the photovoltaic energy to the solar charge controller, and ultimately the battery bank, is done through connections to each panel. Electrical connections to panels and connection to on-board equipment is well known in the industry and does not require further explanation as novelty is not present. Wire 212 would connect to the end of solar panel element 201 and continue connection to corresponding panel elements 202 through 206 by way of a common connection feature. Connection wire 212 would then terminate to a solar charge controller by way of extension on deck or through a port. Additionally, permanent foredeck 112 connection points 210 (four total) may be installed for simplicity and ease of use. Line 213 that holds up the aft end of the boom is called the topping lift.

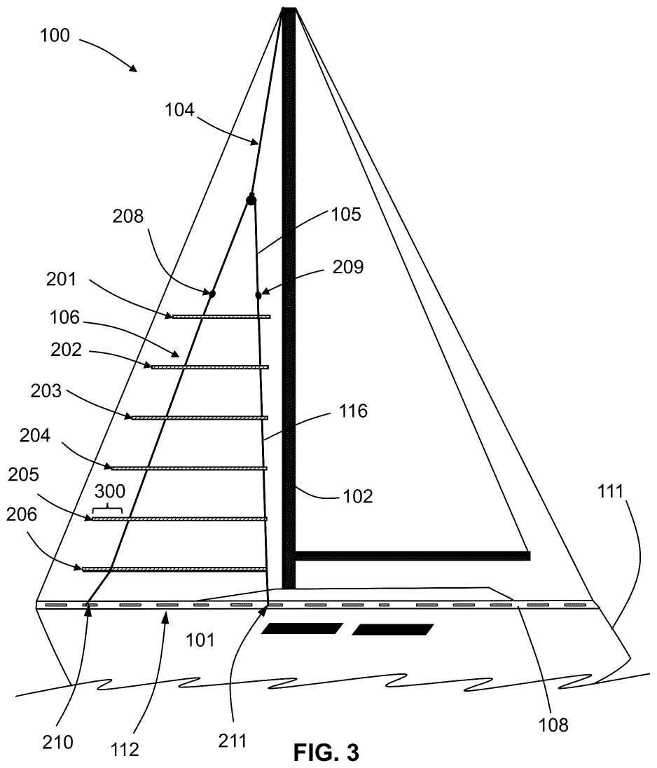

Shown in FIG. 3 side view is another embodiment of the invention to allow for increased solar panel area from elements 201 through 206, in this case longitudinal length, to increase surface area for capturing solar energy. Changing the direct-pull orientation of the forward main lift line 106, or corresponding forward mount line 210, allows for considerably improved kinematics. Changing the direct-pull orientation of the aft main lift line 116, and corresponding anchor point line 211, may also improve the kinematics of the array. As the main halyard 104 wants to align with the base connection points 211 and 212, the kite structure wants to pull, kinematically, in one central line. Having the main lift 106 connection points only attached to the forward corners of panel elements 201-206 limits the longitudinal length of the panels. Allowing for connection line 106 to connect to downstream connection points results in a more stable structure and allows for panel elements 201-206 to extend longitudinally forward of the connection points. The distance increase 300, can be substantial for limited size sailboats, or in sailboats with significantly tall mast 102 relative the foredeck 112 forward to aft length available. For example, distance 300 could be 1.0 to 36 inches. In FIG. 3 as shown, if the forward connection points to panel elements 201-206 were moved to the forwardmost corners of the panels, then the entire kite structure would move rearward and into mast 102, towards stern 111.

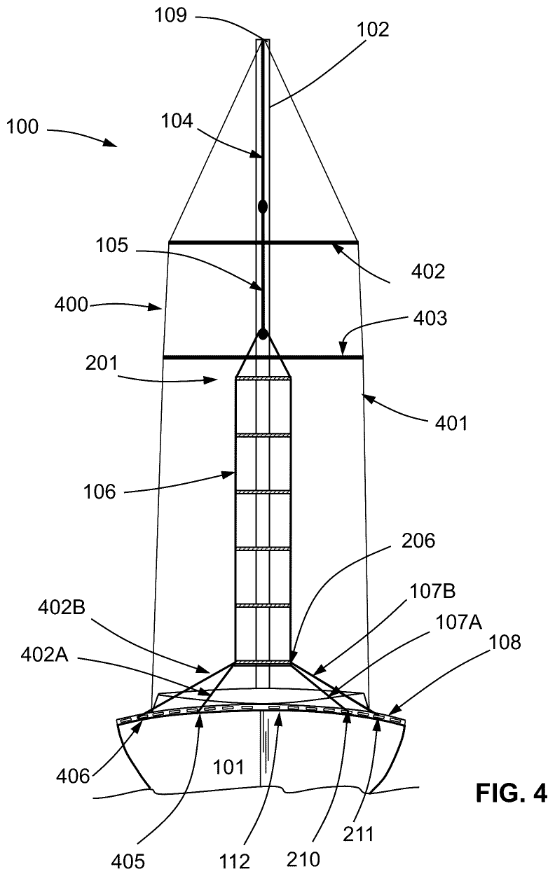

Referring to FIG. 4, showing a view from the forward portion of sailing vessel 101 towards the rear of the vessel. Solar panel array 114 can be seen in the horizontal attitude as deployed in the use position for the embodiment. Main halyard 104 can be seen connected to secondary lift line 105 and further connected to lift lines 106 (line 116 hidden). Finally, base connection lines 107A, 107B, 402A and 402B, part of or independent of line 106 (and similarly hidden line 116), are shown connected at points 211, 212, 405 and 406 to permanent foredeck 112 fittings. For the showing of common area constraints upon the sailing vessel 101 deck are sidestay wires 400 and 401 that are used to support and position mast 102. Further horizontal spreader bars 402 and 403 are used to increase rigidity of the mast 102.

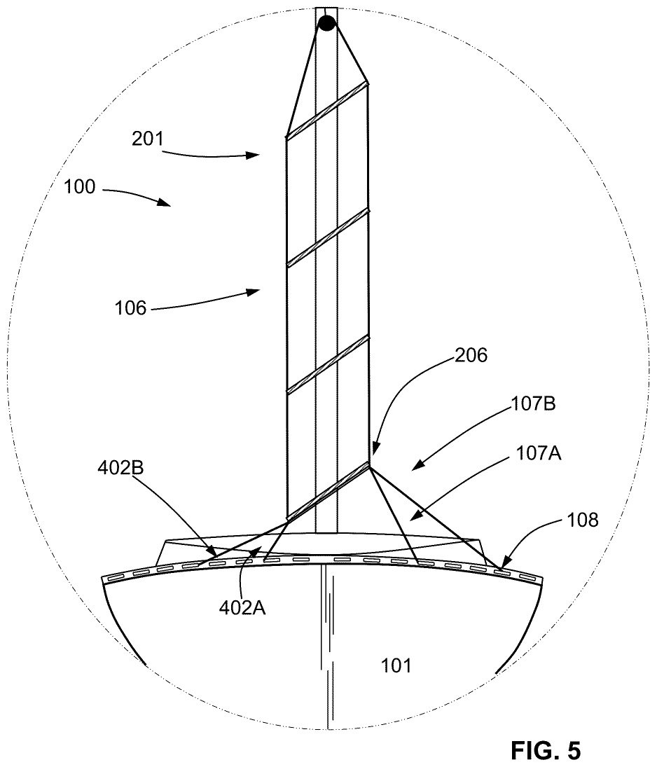

Referring to FIG. 5 is a complementary view to FIG. 4 adding the embodiment of tilting solar panel array 114, panel elements 201 to 206. As base connection lines 107A, 107B, 402A and 402B are adjusted per described methods above, the solar panel elements 201-206 attitude can be changed. In conjunction with self-centering connection points 208 and 209, this embodiment allows for changing the solar panel attitudes to more directly align with the sun's primary location, while at anchor. Although a manual operation, the system design with the use of quick adjustment cleats allows for ease of adjustment as the sun moves through the day. This helps achieve enhanced sun capture over other fixed panel methods, for example, a fixed solar panel on deck or a sailing bimini over the cockpit area.

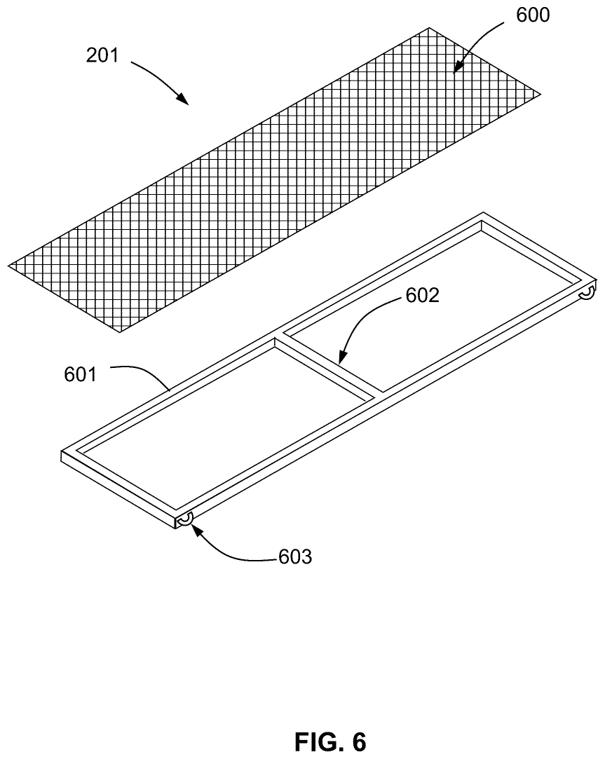

Referring to FIG. 6, the exploded view schematic of one solar panel array element 201 is shown with combined parts shown separately for clarity of the combined assembly as shown in FIG. 1 through FIG. 5. Flexible or rigid solar panel 600 to be attached permanently or semi-permanently to lightweight frame 601. Frame 601 would generally have at least one cross member 602 having mutually affixed ends to frame 601. In one embodiment an aluminum rectangular frame 601 would be used. The aluminum frame 601 would be constructed out of square tubing of gauge 19 to 14 wall and a tubing size of 0.625 to 1.25 inch square. Frame 601 to have welded joints at intersections. In another embodiment, the joints could be pinned or screwed together with corner brackets accepting the square tubing. Finally, the tubing could be made from composite material, or similar lightweight and high strength material. Flexible or rigid solar panels 600 to be affixed to frame 601 upper facing surface by a semi-permanent or permanent attachment. Solar panel 600 attachment can be done using temporary zip ties, screw and washer, or similar. Permanent attachment of flexible panels 600 could include permanent high strength adhesive. Line attachment points to frame 601 can be made by eye, or half-eye, loops 603 near the four corners. In other embodiments, line to frame attachment may be done through holes in the frame, screw-in eyes, or other similar features.

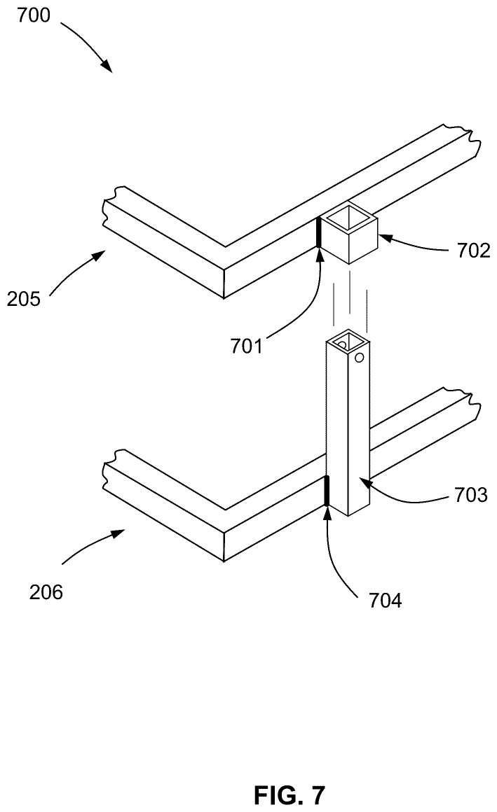

Referring to FIG. 7, a nesting feature 700 is provided for the storage of the vertically stacked panel array 114 when lowering the top halyard 104. The nesting feature 700 includes a vertically upward projecting member 703 that is permanently affixed to frame 601 for panel element 206. In the invention shown, vertical male member 703 is permanently attached to frame 601 using a welded interface 704. This configuration is typical of the four general corners of frame 206. These features could be pinned or bolted depending upon construction methods used for the frame. Coincident with each vertically projecting male base member 703 would be a corresponding female encapsulating feature 702 to accept the vertical member 703. Encapsulating feature 703 would be permanently attached, in this embodiment, to panel elements 201 through 205 independently in the four corresponding corners to base element 206. A push pin or inserted bolt, or similar, can be used to contain the stacked solar panels once nested, 702 over member 703. Solar panel elements for 205 and 206 assemblies are removed for clarity for nesting features.

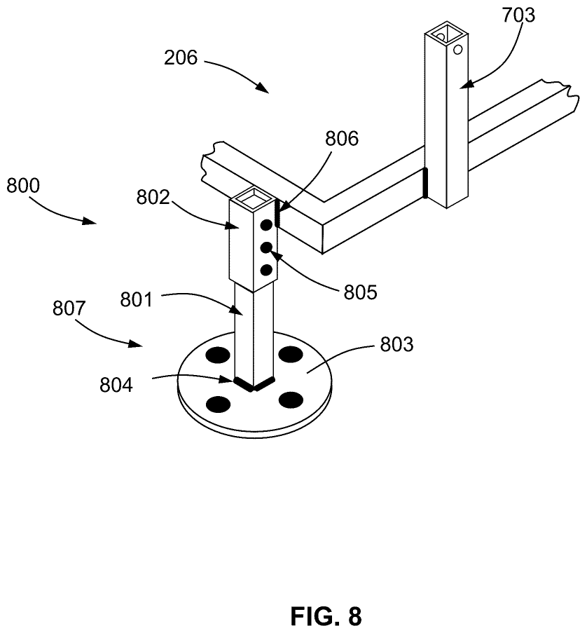

In another embodiment of the invention, referring to FIG. 8, a semi-permanent mount feature 800 is included in the invention. Mounting member 800 consists of a female vertically oriented member 802 that is permanently affixed to bottom element 206. Solar array panel is removed from view for clarity. For embodiment using an aluminum frame the connection between vertically oriented member 802 and element 206 would be done with welding 806 at interfacing corners of member 802. Mounting members 800 would be near the four corners of element 206. Vertical member 802 is shown with corresponding holes 805 to provide for vertical adjustment of base feet 807. The mounting base 807 consists of a vertically and mutually perpendicular member to cylindrical base 803. Projecting member 801 would be affixed permanently to base 803 by welding to the two metallic members 803 and 801. Other embodiments could use bolting between member 801 and base 803, or they may be integrated from composite construction or other methods. Base 803 can be cylindrical in nature or may use other configurations as needed to fit properly with the sailing vessel mount location. In the current embodiment the base structure 807 would be permanently or semi-permanently, mounted to the foredeck or mid-deck of the sailing vessel depending upon said vessel accessibility and use constraints.

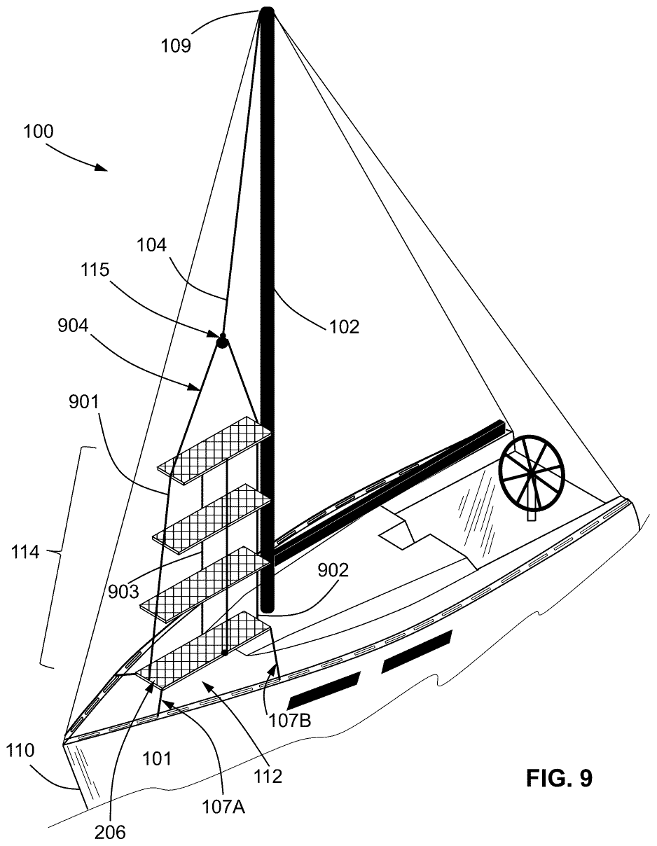

In another embodiment, referring to FIG. 9, a base element 206 is configured with a set of pulleys or wheels along the midline of the longitudinal frame members. Continuous line 903 is fed through pulleys attached to the bottom base frame. Line 903 is then connected directly to each solar panel, or panel frame, above the base panel. Continuous line 904 has the forward portion of the line 901 connected to the base panel at the centerline of the forward frame structure. The aft portion of line 904 has aft line 902 connections to the aft base frame along the centerline of the aft frame structure. Line 904 then connects to the forward portion 901 and aft portion 902 of the remaining panels to distribute them along the vertical direction. Finally, line 904 connects to the top centering lift line 104 with pulley 115 to deploy the vertically spaced panels. The base panel is connected to the foredeck by lines 107A, 107B, 402A and 402B as previously described in FIG. 4.

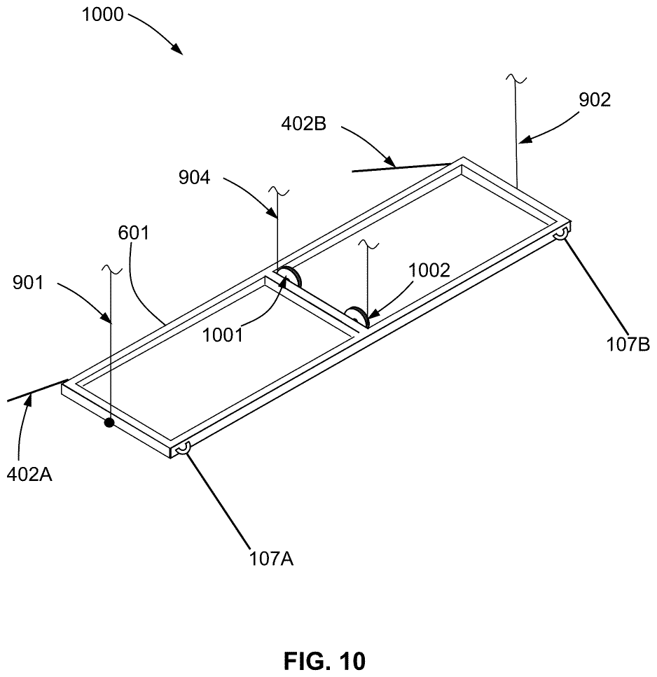

In further embodiment of FIG. 9, referring to FIG. 10, base element 206 system 1000 is used for quick adjustment of solar panel tilting along the longitudinal axis. The base frame 601 uses a plurality of wheels, or pulleys 1001 and 1002 along the midline of the longitudinal length of the base frame 601 long sides. Forward panel lift line 901 would attach to base frame 601 at the transverse center of the front frame member. Aft panel lift line 902 would attach to base frame 601 at the transverse center of the aft frame member. The continuous side tilting adjustment line 903 would pass under pulleys, or wheels, 1001 and 1002. Line 903 would then connect to the general longitudinal midpoints of each remaining solar panel above the base panel keeping the vertical distribution consistent with the forward and aft lift lines 901 and 902. Line 903 can be used for tilting the panels for optimum energy capture as needed. A locking pin going through pulleys 1001 and 1002, or other locking feature, would be used to “lock” lift line 903 once the desired angular orientation of the solar panel elements 201-206 is achieved.

This written description uses examples to disclose the invention, including the best mode, and to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Notwithstanding, the various assembly and mechanical deployment and stabilization techniques, as they relate to the solar array structure, are in no way intended to be limiting and merely illustrate various embodiments. The primary invention, and various alternative embodiments, has been described above, and it is understood that many modifications, substitutions and additions may be made which are within the intended spirit and scope of the invention.

1. A solar panel system and device for providing photovoltaic power comprising: A plurality of photovoltaic solar panels arranged generally horizontally and substantially equally spaced in the vertical upward direction; wherein the solar panel array is placed generally between the mast and sailing vessel forestay; wherein the solar panel array is expandable and retractable in the vertical direction; wherein flexible or rigid photovoltaic solar panels are attached, permanently or semi-permanently, to a lightweight rigid frame constructed of aluminum box tubing, composite construction or similar; the solar panels and frame assembly being substantial size to achieve significantly improved energy capture area; a primary vertical lift using existing top lift line, halyard, from the top of the mast; the primary lift line connected to a single rope lift eye pulley for self-centering; a secondary lift line connecting a forward and aft lift line used to support the distributed solar panels; wherein the secondary lift line is attached to forward and aft solar panel lines by way of a fixed point or use of a single rope lift eye pulley on each end of the line; a plurality of solar panels attached at forward corners by a continuous forward line to the base panel; an aft lift line attached to the aft corners of the solar panels connecting to each panel and down to the base solar panel frame; wherein the panel lift lines are connected to each panel by several means to generally equally space the panels; wherein the four corners of the base element, bottom solar panel, and frame thereof, are connected by lines or rigid members between the base frame and the sailing vessel topdeck; wherein the connection points of the base line are affixed to a mounting location or device on the topdeck; wherein the four base lines may be adjustable for panel adjustability of attitude, tilt angle, along the panels longitudinal axis; wherein the entire solar panel structure is generally mutually in line with the longitudinal axis of the sailing vessel; wherein an electrical connection wire, that is attached to each solar panel, extends downward through a corner of the solar array and finally terminates at a fixed power connection to the topdeck or continues to a solar charge controller and power battery bank using an extension wire.

2. A solar array system as in claim 1, wherein the solar array is placed between the mast and the topping lift, but not connected to the mast other than the top lift, halyard, line.

3. A solar array system as in claim 1, wherein the solar array longitudinal axis is oriented perpendicular to the sailing vessel longitudinal axis.

4. A solar array system as in claim 1, wherein the forward or aft main lift lines that connect the solar panels together have the lines passing substantially away from the corners of the panels allowing for overhang of panels while maintaining a straight line from base to top lift line.

5. A solar array system as in claim 1, wherein a nesting feature is used on the bottom frame with vertically extending male projections that coincide with encapsulating female features on the above panels for the purpose of determinant stacking of stowed solar panels; wherein the vertical projections are near the panel frame corners; wherein the above solar panel frames nest over the base frame projections and use a locking pin, screw, key or similar, to determinant align and retain the panels for stowing as a unit.

6. A solar array system as in claim 5, wherein the solar panel array, when collapsed and stacked, use a mounting system for temporary, but determinant, connection to the sailing vessel topdeck; wherein mounting is done by downward projecting features near the base solar panel; wherein the attachment feature allows for vertical adjustment at each corner to allow for topdeck variability; wherein the mounts have a locking feature such as a pin, screw, key or similar, to fix the position of the stowed array.

7. A solar array system as in claim 6, wherein the solar array is placed between the mast and the topping lift, but not connected to the mast other than the top lift, halyard, line.

8. A solar array system as in claim 6, wherein the solar array longitudinal axis is oriented perpendicular to the sailing vessel longitudinal axis.

9. A solar array system as in claim 6, wherein the forward or aft main lift lines that connect the solar panels together have the lines passing substantially away from the corners of the panel allowing for overhang of panels while maintaining a straight line from bottom to top lift line.

10. A solar panel system and device for providing photovoltaic power comprising: A plurality of photovoltaic solar panels arranged generally horizontally and substantially equally spaced in the vertical upward direction; wherein the solar panel array is placed generally between the mast and sailing vessel forestay; wherein the solar panel array is expandable and retractable in the vertical direction; wherein flexible or rigid photovoltaic solar panels are attached, permanently or semi-permanently, to a lightweight rigid frame constructed of aluminum box tubing, composite construction or similar; the solar panels and frame assembly being substantial size to achieve significantly improved energy capture area; a primary vertical lift using existing top lift line, halyard, from the top of the mast; the primary lift line connected to a single rope lift eye pulley for self-centering; a secondary lift line connecting solar panel elements to distribute solar panels; wherein the secondary lift line is attached to forward and aft end of each solar element by way of a fixed point along the solar element transverse, shorter end, centerline; wherein the continuous secondary, forward to aft, lift line is attached to base solar panel frame; wherein the forward to aft panel lift line are connected to each panel by several means to generally equally space the panels in the vertical direction; wherein the four corners of the base element, bottom solar panel, and frame thereof, are connected by lines or rigid members between the base frame and the sailing vessel topdeck; wherein the connection points of the base line are affixed to a mounting location or device on the topdeck; wherein the base frame uses a pulley system for quick adjustment of attitude of the above solar array elements; wherein a plurality of pulleys are affixed generally midway along the longitudinal length of the base solar panel frame; wherein a central continuous tilting line is place under the base side pulleys; wherein the continuous tilting line is connected to each solar element above the base element; wherein one, or all, pulleys use a locking pin, key or similar to fix the pulley for fixing panel angular position; wherein an electrical connection wire, that is attached to each solar panel, extends downward through a corner of the solar array and finally terminates at a fixed power connection to the topdeck or continues to a solar charge controller and power battery bank using an extension wire.

11. A solar array system as in claim 10, wherein the solar array is placed between the mast and the topping lift, but not connected to the mast other than the top lift, halyard, line.

12. A solar array system as in claim 10, wherein a nesting feature is used on the bottom frame with vertically extending male projections that coincide with encapsulating female features on the above panels for the purpose of determinant stacking of stowed solar panels; wherein the vertical projections are near the panel frame corners; wherein the above solar panel frames nest over the base frame projections and use a locking pin, screw, key or similar, to determinant align and retain the panels for stowing as a unit.

13. A solar array system as in claim 12, wherein the solar panel array, when collapsed and stacked, use a mounting system for temporary, but determinant, connection to the sailing vessel topdeck; wherein mounting is done by downward projecting features near the base solar panel; wherein the attachment feature allows for vertical adjustment at each corner to allow for topdeck variability; wherein the mounts have a locking feature such as a pin, screw, key or similar, to fix the position of the stowed array.

14. A solar panel system and device for providing photovoltaic power comprising: A plurality of photovoltaic solar panels arranged generally horizontally and substantially equally spaced in the vertical upward direction; wherein the solar panel array is placed generally between the mast and sailing vessel forestay; wherein the solar panel array is expandable and retractable in the vertical direction; wherein flexible or rigid photovoltaic solar panels are attached, permanently or semi-permanently, to a lightweight rigid frame constructed of aluminum box tubing, composite construction or similar; the solar panels and frame assembly being substantial size to achieve significantly improved energy capture area; a primary vertical lift using existing top lift line, halyard, from the top of the mast; the primary lift line connected to a single rope lift eye pulley for self-centering; a secondary lift line connecting solar panel elements to distribute solar panels; wherein the secondary lift line is attached to forward and aft end of each solar element above the base element by way of a fixed point along the solar element transverse, shorter end, centerline; wherein the base frame uses a pulley system for quick adjustment of attitude of the above solar array elements; wherein a plurality of pulleys are affixed generally midway along the transverse, short, length of the base solar panel frame; wherein the continuous secondary, forward to aft, lift line is placed under the forward and aft pulleys; wherein the forward to aft panel lift line is connected to each panel by several means to generally equally space the panels in the vertical direction; wherein the four corners of the base element, bottom solar panel, and frame thereof, are connected by lines or rigid members between the base frame and the sailing vessel topdeck; wherein the connection points of the base line are affixed to a mounting location or device on the topdeck; wherein a plurality of pulleys are affixed generally midway along the longitudinal length of the base solar panel frame; wherein a central continuous tilting line is place under the base side pulleys; wherein the side continuous tilting line is connected to each solar element above the base element; wherein one, or all, pulleys use a locking pin, key or similar to fix the pulley for fixing panel angular position; wherein an electrical connection wire, that is attached to each solar panel, extends downward through a corner of the solar array and finally terminates at a fixed power connection to the topdeck or continues to a solar charge controller and power battery bank using an extension wire.

15. A solar array system as in claim 14, wherein a nesting feature is used on the bottom frame with vertically extending male projections that coincide with encapsulating female features on the above panels for the purpose of determinant stacking of stowed solar panels; wherein the vertical projections are near the panel frame corners; wherein the above solar panel frames nest over the base frame projections and use a locking pin, screw, key or similar, to determinant align and retain the panels for stowing as a unit.

16. A solar array system as in claim 15, wherein the solar panel array, when collapsed and stacked, use a mounting system for temporary, but determinant, connection to the sailing vessel topdeck; wherein mounting is done by downward projecting features near the base solar panel; wherein the attachment feature allows for vertical adjustment at each corner to allow for topdeck variability; wherein the mounts have a locking feature such as a pin, screw, key or similar, to fix the position of the stowed array.
